(19) United States
(12) Patent Application Publication
(10) Pub. No.: US 2008/0029043 A1
(43) Pub. Date: Feb. 7, 2008

(54) ANIMAL PROCESSING STATION

(75) Inventor: Rodney John Lawrence, Tauranga (NZ)

Correspondence Address: DARBY & DARBY P.C., P.O. BOX 770, Church Street Station, New York, NY, 10008-0770, US

(73) Assignee: GALLAGHER GROUP LIMITED, Hamilton (NZ)

(21) Appl. No.: 11/833,352

(22) Filed: Aug. 3, 2007

(30) Foreign Application Priority Data
Aug. 4, 2006 (NZ) 548995
Feb. 13, 2007 (NZ) 553214

(51) Int. Cl. A01K 1/02

(52) U.S. Cl. 119/501; 119/498

(57) ABSTRACT

The invention relates to a set of components configured to form an animal processing station, the set of components including at least two side panels which, when assembled, define two opposite sides of the animal processing station, and a base panel, wherein the base panel is configured to removably interlock, either directly or indirectly, with at least two diagonally opposite ends of the opposite side panels and wherein at least one of the panels is formed from a reinforced moulded material.

### TECHNICAL FIELD

The present invention relates to animal processing stations and components therefore.

### BACKGROUND ART

Animal processing stations are widely used in animal management applications. In particular, animal crates can constrain animals while they are processed, treated or measured for example. The use of animal crates for handling animals facilitates regular processing, which can improve the health of animals and farming efficiencies.

Existing animal crates are conventionally made from metals such as steel or aluminium and generally consist of a set of a mounting frame which locates a set of side walls and a floor or base.

Conventional crates are typically constructed using welding. This type of construction is generally considered necessary if the crates are to be sufficiently robust and rigid against the forces animals exert when constrained.

Welded metal crates provide excellent strength and rigidity. Welding is an intrinsically rigid form of construction and readily available tube or box section metals can be used.

However, metals tend to be a relatively expensive material to use in constructing crates. Welding is also a relatively expensive form of construction, particularly if the welding needs to be performed on a farm site to assemble a crate. Generally additional cost is incurred as welding equipment needs to be transported to the site in addition to a skilled welder.

Furthermore these types of welded metal crates include (due to the nature of manufacture) a number of pinch points or sharp edges which can injure livestock or human operators.

Metals are also prone to corrosion in a number of farming environments. For example, in piggery applications animal waste products can have a severely detrimental effect on any exposed metal surfaces, potentially requiring a further galvanising step to be completed in the construction of such crates. As a result, in the majority of piggery applications stainless steel is used to manufacture crates, adding significant costs not only in purchasing raw material but also in fabrication costs.

It is an object of an aspect of the present invention to provide an animal crate that is economically manufactured and maintained, or at least to provide the public with a useful choice in animal crates. An animal crate which addresses the issues present in construction of existing metal animal crates, and which preferably eliminates sharp or rough edges and pinch points in the finished crate, would be of advantage.

Conventionally animal crates tend to be heavy by the nature of their construction. The weight of the crates imposes limitations on their transportation. Furthermore, conventional welded crates can not readily be disassembled, which means the crates are relatively bulky to transport. These transportation issues of present animal crates limit the use of a single crate at different sites. They also limit a vendor's ability to sell the crates at one point and deliver them to a point of use. For example, mail order distribution of welded metal crates is unlikely to be practical.

It is an object of an aspect of the present invention to provide an animal crate that is readily transportable, or at least to provide the public with a useful choice in animal crates.

Animal and operator welfare during use of metal crates can also be an issue. An animal may commonly be in an excited and agitated state as it approaches and enters an animal crate. It is very common in such instances for an animal to contact the crate, often violently. This contact frequently rattles the crate, creating a very noisy environment as the metal components move against one another. This noise may not only increase the agitation of the animal but also results in a very noisy environment for any operator in the vicinity of the crate.

Furthermore, conventional metal crates are generally constructed as an open frame allowing an animal inside the crate to look through it with relative ease. This ability to see outside the crate may add to the general agitation of the animal as it searches for a way out, or tries to determine what is happening to it.

The open frame structure may also lead to an agitated animal lashing out, resulting in a limb or head getting entangled in the frame of the crate. This not only poses a health hazard for the animal, it also increases the processing time while the animal is disengaged adding cost to the processing.

These factors may exacerbate any agitation of an enclosed animal, increasing the difficulty of an operator to work with the animal.

A rigid framed metal crate can also provide problems for cleaning and maintenance of the crate as access to its confined interior can be limited.

It is an object of an aspect of the present invention to provide an animal crate that addresses these issues with animal and operator welfare, or at least to provide the public with a useful choice in animal crates.

Processing animals may often involve collecting information about the animals. For example, an animal is often weighed using weighing sensors placed underneath the animal crate.

Furthermore, processing an animal may often involve reading data from Radio Frequency Identification Tags (RFID tags) associated with the animal. These tags can be read with an antenna associated with the crate. The antenna may conventionally be fastened to the outside of the crate where it is relatively unlikely to be damaged by the animal.

However, a problem with conventional crates is that the metal used in their construction interferes with radio frequency signals sent between the RFID tags and the RF antenna of the tag reader. It is therefore an object of an aspect of the present invention to provide an animal crate that minimises RF interference, or at least to provide the public with a useful choice.

Furthermore, it would also be of advantage to provide an improved animal crate which provided an integrated solution to animal processing which could include weighing, ID reading, sorting and/or drenching processing operations.

The fixing of an RFID antenna to a point where it is unlikely to be damaged is often problematic as the antenna needs to be situated in a position that gives it good communication with the area inside the crate. The antenna also needs to be in a position where it is relatively unlikely to be damaged by not only the animal but the person handling the animal.

It is therefore an object of an aspect of the present invention to provide an animal crate which facilitates robust stowage of an RF antenna, or at least to provide the public with a useful choice in animal crates.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a set of panels configured to form an animal processing station, the set of panels including;

at least two side panels which, when assembled, define two opposite sides of the animal processing station; and

at least one base panel,

wherein at least one base panel is configured to interlock, either directly or indirectly, with at least two opposite ends of different side panels and

wherein at least one of the panels is formed from a reinforced moulded material.

According to another aspect of the present invention there is provided a set of components which form an animal processing station substantially as described above, said set of components also including at least two end components which, when assembled, define opposite ends of the animal processing station.

According to yet another aspect of the present invention there is provided a set of components substantially as described above which also includes at least one roof panel.

In a preferred embodiment an animal processing station provided in accordance with the present invention may be provided or described as an animal crate. Animal crates are well known in farming or animal husbandry applications and generally form an enclosure in which an animal can be restrained for a processing operation. Preferably the present invention may be used in this application to form an animal crate, and reference throughout the specification will be made to same.

Preferably at least one side panel includes a door. A door in a side panel, which may be configured to swing open (away from the interior of the animal crate when assembled, or to slide along the side of the side panel, may be used to provide an opening for a user (such as a veterinarian) to access an animal inside the animal crate.

Preferably, when assembled, at least one base panel can be employed to secure relative to one another at least two pairs of opposite ends of different side panels.

Preferably a base panel may provide a stabilising and strengthening element to the crate. The base panel may assist in engaging together preferably at least two side walls of the crate, generally by connecting the side walls at opposite distal end corners of the crate. In such embodiments, the base may preferably extend at least diagonally across the central cavity defined for an animal by the crate. The strengthening provided by the base allows an individual set of panels making up the sides of the crate to be firmly locked together, thereby preventing an animal from forcing its way out of the crate by diverging the side walls from one another.

In general, the base panel component may be provided by a substantially planar element which extends across the intervening area of a cavity defined between the side panels. In some embodiments a base panel may be connected to all four bottom corners of the side panels when two flat side panels only are provided.

In a preferred embodiment a base may indirectly connect or interlock together the side wall panels through connection to an end component. In such embodiments the base may be directly locked onto or connect to two end components which in turn directly lock or connect to the side wall panels. Through the use of intermediate end components, the base can assist in locating and locking the side panels into the resulting crate structure.

In a preferred embodiment the set of components may also include at least one roof panel configured to interlock, either directly or indirectly, with opposite ends of different side panels. In a further preferred embodiment, a roof panel may secure relative to each other at least two pairs of opposite ends of different side panels. In a further preferred embodiment a roof panel may secure relative to each other at least two pairs of upper corners of different end components.

Preferably, such a roof panel may function in effectively the same manner as the base component. Such a roof panel may directly or indirectly engage together preferably two side wall panels of the crate, generally by connecting the side wall panels at the opposite distal end corners of the crate.

In a preferred embodiment a roof panel may indirectly engage with a side wall panel through an end component. Such a roof panel may be connected or locked onto a top surface of an end component which is in turn engaged or locked onto a side panel. Such a roof panel may alternatively be connected onto the top outer corners of two end components which in turn support two side panels. This indirect connection scheme allows a roof panel to assist in locking such side wall panels to the crate to be assembled.

In a preferred embodiment a roof panel may encase wiring and provide mounting for a control unit for an RFID antenna or other electronic components.

In a further preferred embodiment the roof panel may also include or be formed by a central ‘I’ beam structure to be connected to two opposed end components. Furthermore, such a central beam may encase wiring and provide mounting for a control unit for an RFID antenna or other electronic components. However, it will be appreciated that other forms of room panel may be configured to encase wiring and provide a mounting for a control unit, and that reference to an “I” beam structure only throughout this specification should not be considered limiting.

An advantage of an “I” beam structure for the roof panel is that, when assembled, it provides an opening between each side of the “I” beam and a side panel, thus allowing a user access to an animal inside the animal crate.

In a preferred embodiment a roof panel may be hinged to an end component. This allows the roof panel to be swung open allowing access to any wiring or other electronic components, for example if servicing is required.

In a preferred embodiment the set of components may include a control unit provided separately from the roof panel. This means that a control unit (preferably including a user actuation means for controlling any electronic components of the crate), may be attached to the central beam after the crate is formed. This means the control unit can connect to the central beam and the wiring or piping within this beam, in a number of configurations.

This control unit may preferably be removably connected to the roof panel and may be attached and rotated depending on the preference of a user. For example, a right handed user may have the control unit on in one configuration, and a left handed user may rotate this by 180 degrees to suit their preferences. As the wiring to the crate may be encased in the central beam of a roof panel, the control unit can be connected in a configuration to suit the user. This means it is not necessary to move the whole crate to change the control configuration, making the system more flexible.

Preferably the combination of the roof panel and base may be configured to indirectly interlock together the side panels relative to one another and prevent an animal escaping from the crate.

In a preferred embodiment the side panels provided may be located within the resulting crate structure via connections to two end components of the structure. In a further preferred embodiment such end component connections may provide the facility for side panels to be located at a range of positions. This can allow for adjustment of the relative positioning of the side panels with respect to one another, to allow each side panel to be moved into or out from the interior volume defined by the crate.

In a preferred embodiment the position of a side panel with respect to an end component may be adjustable.

For example, a crate's end components and side panels may be connected together through the use of locking pins which engage with complementary slots. A single locking pin may be used with an array of complementary slots which provide a range of locking positions for one corner of a side panel. Preferably such pin and slot arrangements may be provided for each of the four corners of a side panel in a preferred embodiment. Furthermore, such complementary arrays of slots may be formed interchangeably on either a side panel or an end component.

This adjustable side panel positioning system allows the dimensions of the interior of the crate formed to be changed readily. For example, the interior volume of the crate may be reduced for small animals or increased for larger animals on demand.

Preferably through the provision of locking pins and complementary slot arrays such side panels may be readily moved and lifted out of the remaining crate structure to allow for cleaning of the interior of the crate.

When electronic or RFID systems are also employed with the crate, the ability to adjust the position of a side wall which contains an antenna allows for a reduction in false tag reads of animals not currently located within the crate.

In a preferred embodiment the side panels include a ramp projection along an edge which, when assembled, forms a bottom interior edge for the animal crate. This ramp projection can be used to guide an animal's feet towards the centre of the crate.

Preferably, a base panel and at least one side panel may be configured to interlock directly together. For example, in some embodiments, the components provided may be engaged through use of a mortise and tenon arrangement. This allows secure joining of the at least two panels, without the need of other attachment means. This means that the panels, and the crate, can be formed in substantially one material

In a preferred embodiment the panels provided may in the main be formed from plastic materials. Plastic materials are lightweight and inexpensive, and also resistant to corrosion in comparatively harsh environments. Furthermore, plastic is a non-ferrous material which does not interfere with the operation of a radio frequency signal transmission scheme. Alternatively the panels provided may be formed from other malleable materials such as fibreglass.

Preferably, at least one of the roof, side or base components are formed from rotationally moulded plastic. In a further preferred embodiment, the bulk of the panels provided may be formed from rotationally-moulded components. Rotational moulding techniques can allow relatively large articles to be manufactured quickly and inexpensively, and may also incorporate hollow cavities which can run cabling from various processing system or elements associated with the crate provided.

The material of the panels may preferably be non-conducting. Therefore, as the panels interlock, needing no further attachment means, the crate provided would provide little or no interference to any radio frequency emitters or receivers operating in the area. This is of particular advantage when an antenna is located on a side panel of a crate. The antenna can easily read an animal's radio-frequency identification tag, without interference from the crate or other components.

A reinforced panel (or end component) may be formed from a combination of an external layer and a secondary layer attached to the interior surface of the external layer, such that the finished panel is stronger than the external panel alone.

A panel may be formed by initially rotational-moulding an exterior layer from granulised polymer particles, as is well know in the art. A reinforced panel may then be formed by rotational moulding of a secondary layer inside the exterior layer, the secondary layer providing additional rigidity and strength to the finished panel.

Preferably this secondary layer may be composed of a layer of polymer foam, such as polyethylene foam. The internal secondary layer of polymer foam may be of a sufficient thickness to provide the necessary rigidity and strength to the multi-layer panel.

Preferably the thickness of the layer of polymer foam formed on the interior of the external layer is such as to leave a cavity in the interior of the panel.

Alternatively, the foam material may expand to fill the interior of the panel and give strength to the panel. The foam material may also include fibre reinforcement.

In some embodiments the panels may be reinforced during moulding by the addition into the mould of materials or elements that have a rigidity higher than the external layer while the panel is rotationally moulded. This can provide a lightweight, substantially plastic panel that has the required strength to resist forces such as an animal kicking the panel. Such a reinforced panel may be robust and strong in the presence of such force being exerted on it.

In some embodiments a polymer and fibre reinforcement mixture may be used to reinforce an external layer. For example the secondary layer may be composed of a mixture of granulised polymer and long glass fibres, where the size of the granules in the secondary layer may be larger than the size of the granules used in moulding the exterior layer.

The fibre reinforcement (such as glass fibre) is dispersed throughout the polymer, making it stronger than the polymer alone. As the strong secondary layer is formed inside the normal plastic (polymer) layer, the panel may be stronger than a single plastic layer only.

In a further alternative embodiment, the panel may be reinforced by the inclusion of an internal strengthening element such as a wooden, steel or ceramic element. This element may be inserted before rotational moulding and the panel created around it.

Any combination of secondary layers, including polymer foam reinforcement, polymer and fibre reinforcement, reinforcing internal elements, or other reinforcing means may be used to provide reinforcement to the panel. Reference to one or another of these means only throughout the specification should in no way be seen as limiting.

In a further embodiment, the crate provided may also include an outer framework disposed around, but isolated from the side panels, and preferably the base panel. This outer framework may be isolated from a weighing apparatus used to support the remaining components of the crate, thereby allowing an operator to lean on or contact the outer frame without effecting a weight measurement being recorded for an animal within the crate.

Preferably, a side panel may include at least one upper member, at least one lower member and at least one intermediary member which is substantially planar, wherein the at least one planar intermediary member is adapted to interlock between upper and lower members for assembly.

Preferably, at least one side panel includes at least two planar members arranged parallel with each other when the animal handling crate is assembled.

Preferably, when assembled, the set of components define an inlet for the animal handling crate.

Preferably, the set of component includes at least two closure elements adapted to close together to close the inlet of the animal crate. Preferably, the at least two closure elements are adapted to slide together.

Preferably, when assembled, the set of components defines an outlet for the animal handling crate. Preferably, the outlet component includes at least two sliding elements adapted to close together to close the outlet of the animal crate.

Preferably, at least one closure element may include at least one upper member, at least one lower member and at least two side members, wherein these members are adapted to interlock for assembly.

Preferably, at least a portion of the base panel may be inclined towards the side panels when the components are assembled. In some such embodiments the inclination of the surface of the base panel may be such that, when assembled and in use, the interior surface of the base panel is configured to divert an animal's legs to the centre of the base panel and thereby potentially reduce their ability to change their direction of movement within the crate or to slip over.

In alternative embodiments, the inclination of the surface of the base panel may be such that, when assembled and in use, the interior surface of the base panel is configured to drain fluids away from the centre of the base of the animal crate to the edges.

Preferably, the base panel may include some form of tread pattern such as, for example, traction ridges extending transverse to a main axis of the base panel.

In a preferred embodiment, the interior cavity formed by the crate may be configured to receive at least one removable insert. For example, in some embodiments hog bars may be inserted into such cavity to keep hogs upright and prevent them from sleeping inside the crate.

In other embodiments this feature may be provided by panels in either side of the crate which are adjustable to provide narrowing. This narrowing can ensure smaller animals cannot turn around and jam the flow of animals through the crate. Preferably, at least one of the roof, side or base panels are adapted to receive connection pins to secure components of the assembled animal handling crate together.

Preferably at least two of the components are adapted to interlock together. For example, in a further preferred embodiment these components may be interlocked together through use of mortis and tenon arrangements. Those skilled in the art should however appreciate a range of different types of attachment schemes, ranging from locking pins through to tongue and groove arrangements, may also be employed in conjunction with the present invention.

In a preferred embodiment at least one component may include an electromagnetic antenna. In a further preferred embodiment, at least one side panel may include an electromagnetic antenna. Preferably as these components may be formed from plastic material, the materials of the components need not necessarily interfere with the operation of such an antenna. Furthermore, such an antenna may be provided as part of a radio frequency identification tag system, allowing automated identification of animals retained in the crate.

Preferably a base panel may include at least one load cell moulded into the base panel. In a preferred embodiment a load cell can be located at each corner of a base panel. This allows the weight of the animal to be measured while in the crate. This also avoids the need for a crate to be used in combination with a preexisting load cell apparatus on which the crate must be placed. This means there is no extra height in the system, and the animal can enter the crate easily.

Preferably, at least one of the roof or base panels may be formed by rotationally moulded plastic. Preferably, the side panel includes at least one cavity therein. This may be a result of the rotationally moulded process. It may be desirable to reduce the weight of the panels and the hollow cavity may achieve this. As the panel is reinforced, there may be a further cavity which may be filled with structural foam or other types of composite reinforcing. The cavity may also be used for internal wiring for electronics inside the side panel.

Preferably, when assembled the components may include a sorting box to be appended to the animal handling crate. Preferably, the sorting box and animal handling crate are adapted to be connected by pins.

Preferably, when assembled, a sorting box includes at least one inlet, at least two outlets communicable with the inlet and a swing door adapted to be movable to close off either outlet from the inlet.

According to another aspect of the present invention there is provided an animal processing station formed from a set of components substantially as described above.

Preferably, when assembled, the panels provide a strong, substantially plastic, animal crate which is light and easy to transfer in storage. The animal crate is formed from panels which may include composite reinforcing which will provide a strong resistance to any forces exerted by an animal on the panel. This reinforcing provides a strong, stable panel and allows an open animal crate to be formed from a material which is lightweight and easier to manufacture. The advantage of having light weight panels is that the animal crates can be assembled onsite and moved from place to place.

The present invention may provide many potential advantages over the prior art.

The present invention may facilitate the assembly of an animal crate formed from mostly plastic components. The present invention may be provided as a kit set of panels which may be transported or sold assembled and subsequently assembled where an animal is to be processed. The use of plastic panels may substantially reduce the overall cost and manufacture and such a crate could be disassembled and transported to a number of sites if required. The reinforcing of these panels ensures that the plastic panels provided are strong while suffering none of the disadvantages of a heavy, welded, metal crate as is available in the prior art.

In particular, rotationally-moulded plastic components are generally free of sharp edges and hinge points, as may occur with welded metal crates, which might break the skin of a person handling animals or an animal.

Rotational-moulding typically creates cavities within the components which are filled with structural foam or with composite reinforcing providing a rigid and strong animal crate with relatively low weight in comparison to metal crates. The light weight also makes them economical to transport.

Rotationally-moulding plastic is also an economical form of manufacture. The crates can be assembled by hand on site which also provides an economical means of constructing an animal crate.

The use of a moulded plastic animal crate according to the present invention may also improve the environment for an animal and an operator during use. A significant reduction in noise created when the animal bumps or strikes the crate may be expected due to the use of plastic panels and components rather than metal as in conventional crates.

This noise reduction is enhanced by the inclusion of a secondary layer of polymer foam inside the moulded panels, resulting in noise of much lower frequency and volume than that commonly experienced with metal framed crates. This may lead to a reduction in the agitation of an enclosed animal and a better environment for both the animal and the operators during processing.

The use of solid moulded panels creates a darkened enclosure with very limited opportunity for an enclosed animal to see out of the crate. This generally may lead to a calming effect on the animal, making it easier to work with, and may lead to an increased speed of processing, thus saving costs, as well as an improvement in working conditions for an operator.

The ability to remove the side panels without dismantling the crate allows access to the interior of the crate for cleaning or other servicing. This ready access to the interior of the crate is in contrast to the relatively limited access available in conventional metal crates.

The space in a side component may provide space to stow a radio frequency identification tag reader. Furthermore, a case made from plastic components will not interfere with radio frequency identification signals.

The present invention may also incorporate a connection scheme for side panels and end components which allows the relative position of side panels to be adjusted and for the side panels to be removed easily. An adjustable connection scheme can allow the panels positioned to restrict or increase the width of the cavity defined by the crate depending on the application it is used in and the animals it is employed with.

### BRIEF DESCRIPTION OF DRAWINGS

Further aspects of the present invention will become apparent from the following description which is given by way of example only and with reference to the accompanying drawings in which:

FIG. 1 shows a side schematic view of the animal processing station provided configured in accordance with a preferred embodiment, and

FIG. 2 shows a cross-section view of elements of the interior of the processing station configured in accordance with the embodiment shown with respect to FIG. 1, and

FIGS. 3a, 3b, 3c show plan, side and end views of the animal processing station illustrated with respect to a further embodiment, and

FIG. 4 shows an exploded view of portions of an end component and a side panel shown in FIGS. 3a-3c which illustrates the connection scheme used.

FIG. 5 shows a perspective view of an animal handling processing station provided according to another embodiment of the present invention;

FIG. 6 shows an alternative perspective view of an animal handling processing station according to the same embodiment as FIG. 5, but in this case a sorting box is appended to the animal handling processing station;

FIG. 7 shows an alternative perspective view of an animal handling processing station and sorting box according to the same embodiment as FIG. 6;

FIG. 8 shows an alternative perspective view of an animal handling processing station and sorting box according to the same embodiments as FIGS. 5 to 7;

### BEST MODES FOR CARRYING OUT THE INVENTION

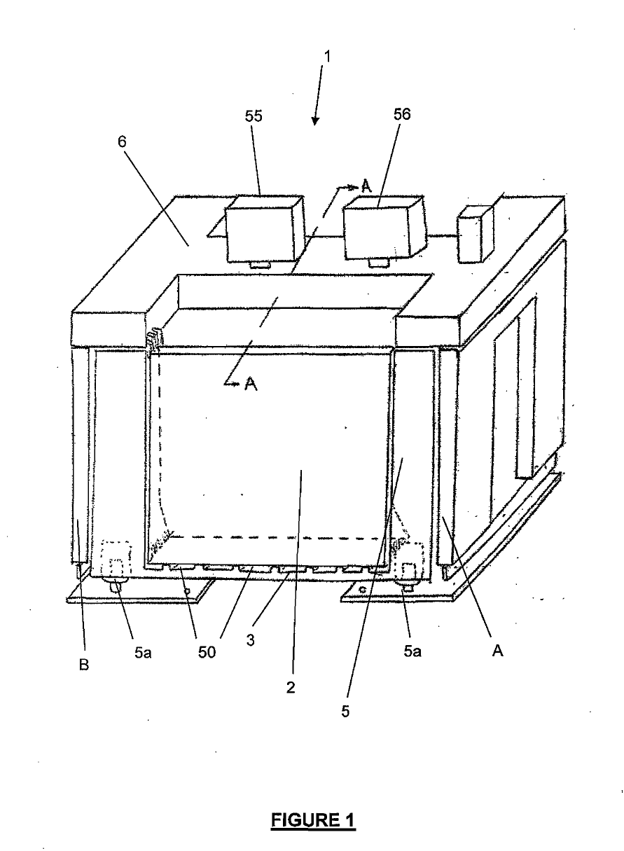

FIG. 1 shows a side view of an animal processing station in the form of an animal crate (1) provided in accordance with one embodiment of the present invention. The animal crate, (1) in this embodiment includes a pair of side panels (2) (only one side panel shown in this view) and a base panel (3) adapted to secure the two opposite ends of the different side panels. The base panel (3) is configured to include a tread pattern (50).

The base panel and side panels (2) are formed from rotationally-moulded reinforced plastic material.

Sliding doors, A and B, are formed within a pair of end components (5). These include a slide rail (5a) which allows the doors to slide open and close to let an animal in or out of the crate.

Also shown is a roof panel (6) in the form of a substantially ‘I’ beam shaped central member. This central beam member runs the length of the crate (1) and functions in substantially the same way as the base by connecting directly to each of the two end components (5). The roof panel (6) encloses electrical wiring and devices to aid with the processing of the animal (weighing, identifying etc).

A control unit (55, 56) is mounted on the roof panel (6)

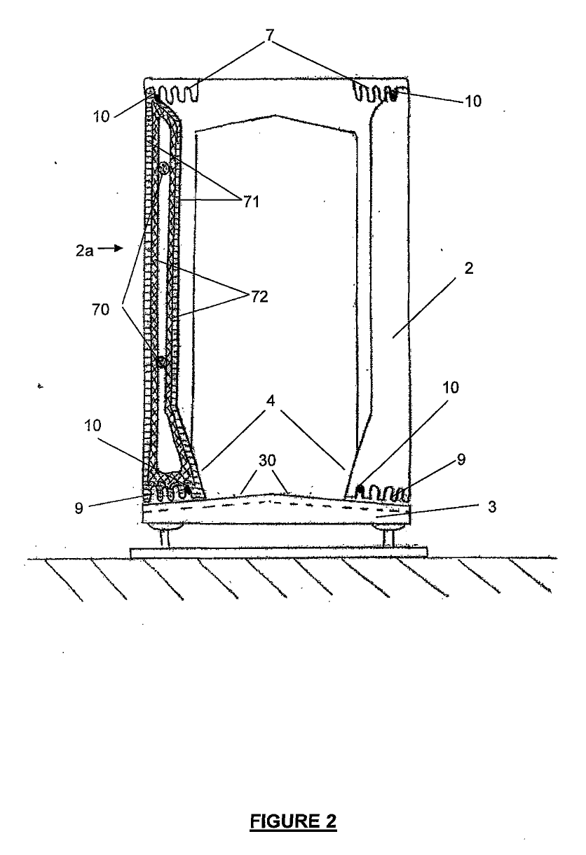

FIG. 2 shows a side cross-sectional view of the invention illustrated in FIG. 1. FIG. 2 shows the two side panels (2), and a base panel (3). This base panel (3) has a surface which is inclined slightly from the centre which aids with cleaning and draining any liquids from the centre of the animal crate to the edges.

As shown in this drawing, the side panels (2) also include an inclined bottom section (4). This helps to direct an animal's feet away towards the centre of the crate and makes it difficult for the animal to turn around in the crate.

A side panel (2a) is shown in cross section in FIG. 2. An external layer (71) is formed from rotationally moulded plastic. A secondary layer (72) is rotationally moulded inside and against the external layer (72). The secondary layer (72) is formed as a relatively thick (in comparison with the external layer (71)) layer of polyethylene foam.

An antenna (70) is shown located in the interior cavity of the side panel (2a).

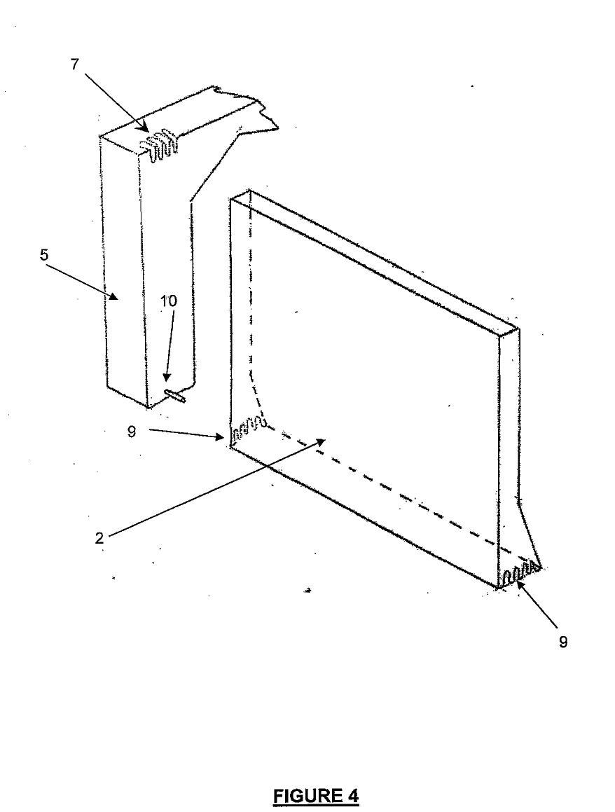

FIG. 2 also illustrates components of a locking system employed to connect side panels (2) to end components (not fully shown), as discussed in further detail with respect to FIG. 4.

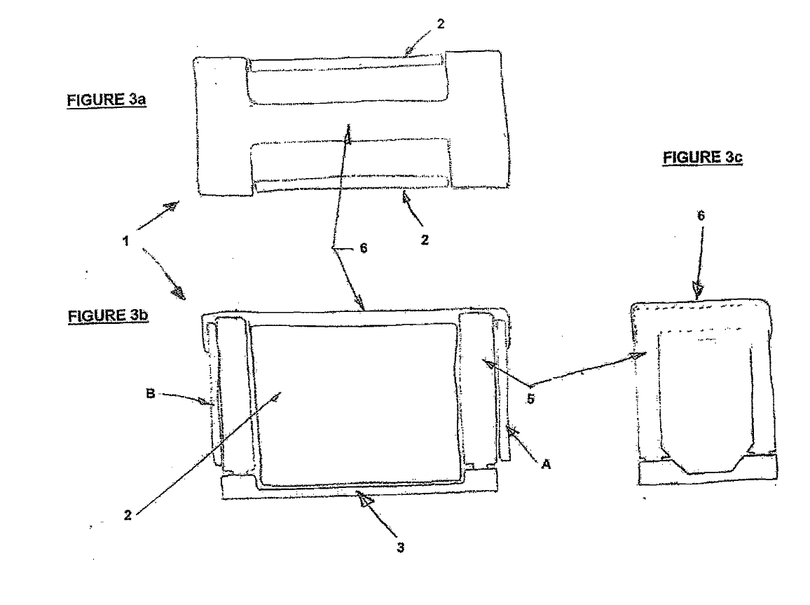

FIGS. 3a, 3b, 3c show plan, side and end views of an animal crate (1)

FIGS. 3a to 3c show an animal crate (1) including side panels (2), a base (3), a pair of end components (5) and two doors (A, B).

FIG. 4 shows an exploded view of portions of an end component and a side panel shown with respect to FIGS. 3a-3c illustrating the connection scheme used.

FIG. 4 illustrates how a side panel may be readily connected into or removed from the crate formed, while also providing a range of positions at which the side panel may be located or locked into the crate.

This connection scheme employs an array of complementary slots (7) formed in the top section of one corner of an end component. The slots (7) are formed with a complementary shape to that of a locking pin (8) projecting from each of the top corners of the side panel (2).

The bottom corners of the panel (2) define an array of complementary slots (9) which in turn engage with a locking pin (10) formed in a bottom corner of each end component (5).

As can be seen from FIGS. 2 and 4, the extent to which the side panel projects into the interior of the crate, and also the angle of the interior surface of the panel, can be adjusted depending on which slot a locking pin is located within. This adjustment facility allows the volume defined or enclosed by the crate to be increased or decreased, for example to accommodate larger or smaller animals.

Furthermore, the position of a side panel (2) incorporating an electronic identification system (as shown in FIG. 2), such as an RFID reader antenna (70), is adjustable to reduce the chances of false tag reads being taken from animals not inside in the crate.

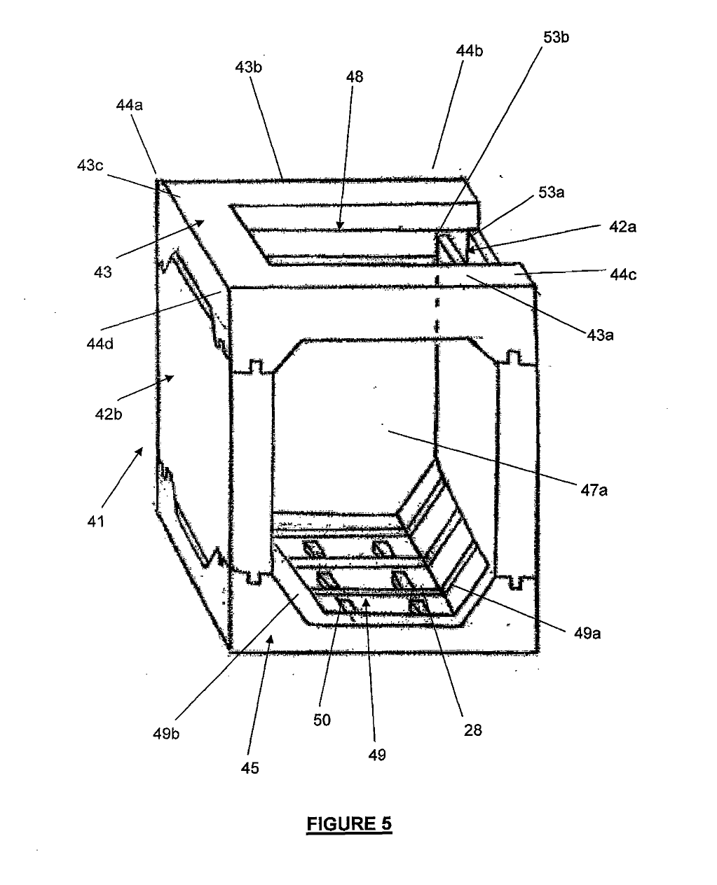

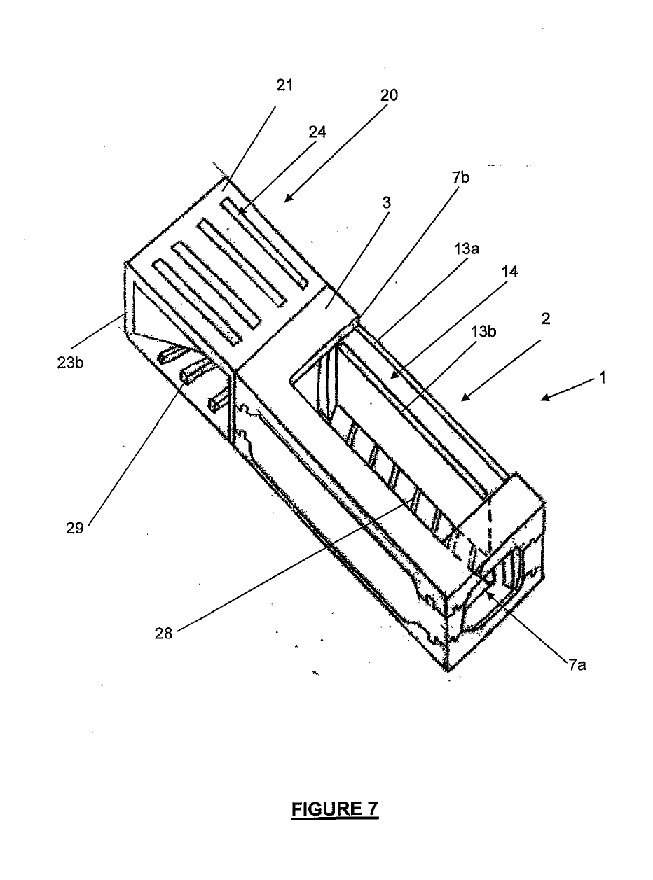

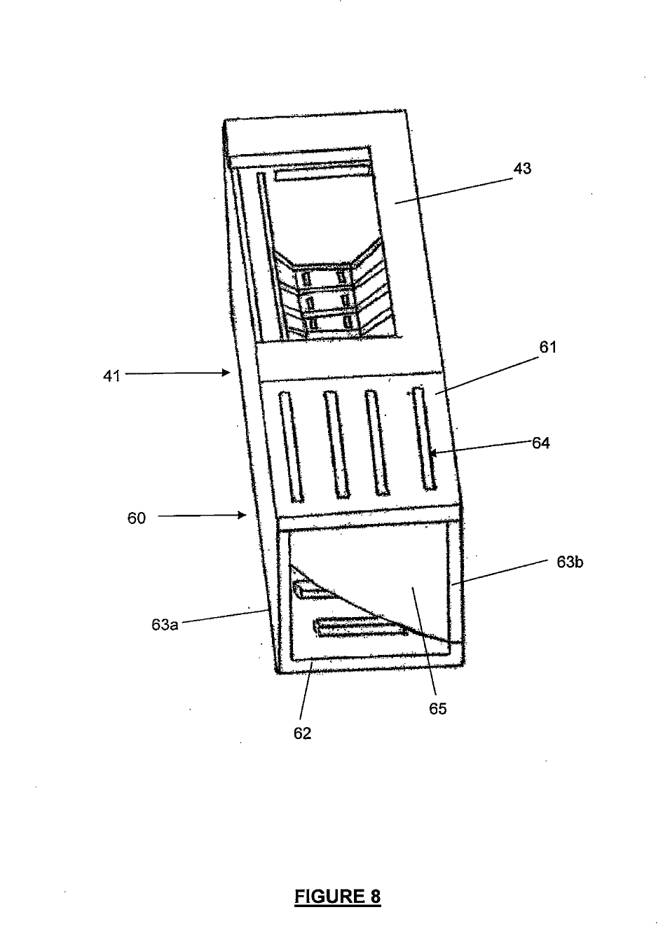

FIG. 5 shows another embodiment of an animal crate (41) for handling animals while they are being processed. The crate (41) is assembled from a set of components (not shown individually). The components are described herein in reference to FIGS. 5 to 8 in terms of their function and location in the assembled crate.

Two side components (42a) and (42b) are preferably secured opposing each other. A roof component (43) is secured over the side components (42a) and (42b). The roof component (43) has four bores (44a) to (44d) which receive pins (not shown). These pins secure the roof component (43) in place over the side components (42a) and (42b) and thereby secure the side components (42a) and (42b) in place with respect to each other. These side components (42a) and (42b) also have bores (not shown) which receive pins (not shown) to secure the roof component (43) to the sides (42a) and (42b).

A base component (45) is secured opposite a roof component (43).

The side (42), roof (43) and base components (45) collectively define an inlet (47a) and an outlet (47b) for the crate (41).

The roof component (43) is formed in a ‘C’ shape sheet to provide an access aperture (48) for a person processing an animal in the crate (41). The width of the ‘C’ section (43a, 43b and 43c) ensures that the roof component (43) is rigid. In particular, they ensure it is rigid in respect to the relative location of points at opposite diagonal corners of the roof (43). For example an end of a limb (43a) is rigidly secured with respect to a distant end of the spine (43c), near to where it connects to the limb (43b). As the roof (43) is secured to the sides (42a) and (42b), the rigidity of the limbs (43a) and (43b) and spine (43c) ensures that opposite ends of the different side components (42a) and (42b) are secured rigidly with respect to each other. This is, they are locked in a relative position and cannot move past each other.

The top of the base (45) defines a floor element (49) secured between the side elements (42a) and (42b).

The edges of the floor component (49a) and (49b) are inclined towards the sides (42a) and (42b).

The floor includes tractions ridges (50) running transverse to the floor. The traction ridges (50) may be replaced or complemented by a grip tread (not shown).

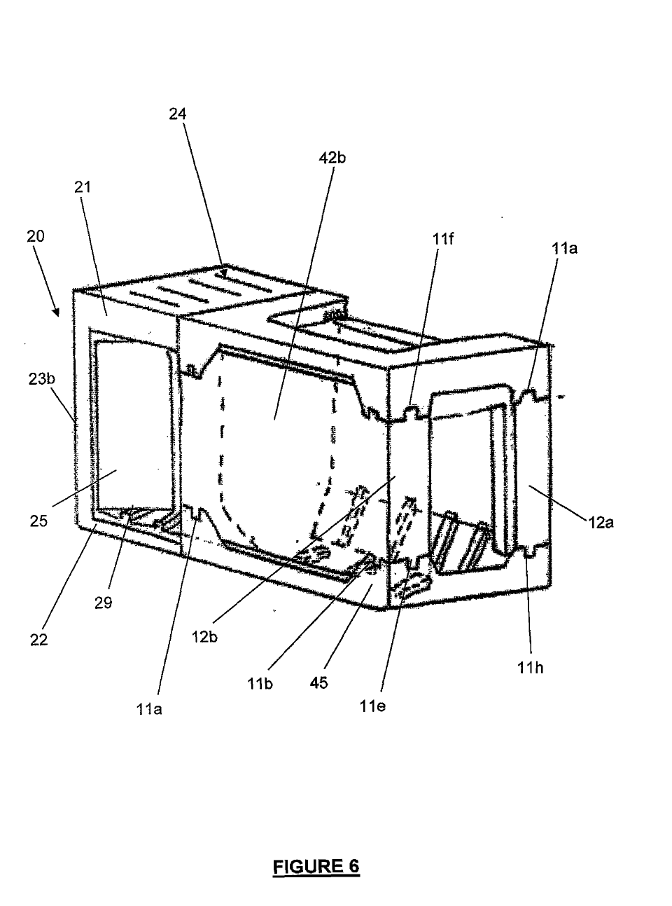

Referring to FIG. 6 in particular, the base component (45) provides interlocking features (11a) to (11d) in the form of mortises or tenons, or similar, to allow the side component (42b), for example, to interlock with the base component (45).

The side components (42a) and (42b) may have end portions (12a) and (12b) respectively along with end portions (12c) and (12d) (not shown). These end portions interlock with the roof component (43) and the base component (45) at interlocking points (11e) to (11h).

An animal sorting box (60) can also be connected to the outlet (47b).

The sorting box has a roof component (61), a base component (62) and pillars (63a) and (63b).

The roof has viewing or ventilation apertures (64) formed in it.

The sorting box (60) preferably has a swing door (65) which is hinged at a pillar (63b), for example, and closes or delimits outlets (66) and (67) from an inlet (not shown) which communicates with the outlet (47b) of the animal crate (41).

As shown in FIG. 5, the side component (42a) preferably has an inner layer (53a) and an outer layer (53b) which provide a space (54) between them. This space may-contain an electromagnetic, radio frequency antenna which forms part of a radio frequency identification tag reader.

The function of the animal crate (41) and sorting box (60) will now be described in reference to FIGS. 5 to 8.

The components of the animal crate can be assembled by placing the base (45) in position then interlocking the side elements (42a) and (42b) into the base (45). Next the roof component (43) is interlocked over the side components. These components can be securely locked in place by the insertion of pins (not shown) into bores (46a) to (46d) which preferably extend through the roof component (43), side components (42a) or (42b) and base component (5).

The top of the base defines the floor which includes inclined sections (49a) and (49b) which incline towards the side components (42a) and (42b). These inclined sections to (49a) and (49b) also assist in urging an animal's feet towards the centre of the crate (41).

The base (45) includes a load cell (not shown in these figures—see FIG. 1).

As the roof member (43) is rigid and interlocks with the side members (42a) and (42b) it transfers force between opposite ends of the two different side components (42a) and (42b) to secure or fix them in place relative to each other. This prevents forces exerted by the animal or the person processing the animal from forcing the side components (42a) and (42b) into a non rectangular parallelogram as the opposite ends of the two different side components are rigidly secured relative to each other.

The sorting box (60) is appended to the crate (41) by tie pins (not shown). The sorting box is assembled by a floor component (62) being connected via columns (63a) and (63b) to the roof component (61). Animals leaving the outlet (47b) of the animal crate (41) are forced into either outlet (66a) and (66b) by the position of the swing door (65).

The ridges (68) of the floor component (69) running transverse to the length of the crate (41) assist the animal in getting traction to move forward. The tread pattern (69) of the sorting crate (60) gives the animal grip to move from the sorting crate (60).

Aspects of the present invention have been described by way of example only and it should be appreciated that modifications and additions may be made thereto without departing from the scope thereof of the appended claims.

1. A set of components configured to form an animal processing station, the set of components including
at least two side panels which, when assembled, define two opposite sides of the animal processing station,
and at least one base panel,
wherein at least one base panel is configured to interlock, either directly or indirectly, with at least two opposite ends of different side panels,
and wherein at least one of the panels is formed from a reinforced moulded material.

2. A set of components configured to form an animal processing station as claimed in claim 1 wherein the set of components includes at least one roof panel, wherein at least one roof panel is configured to removably interlock, either directly or indirectly, with at least two opposite ends of different side panels.

3. A set of components configured to form an animal processing station as claimed in claim 1 wherein the set of components includes at least two end components which, when assembled, define opposite ends of the animal processing station.

4. A set of components configured to form an animal processing station as claimed in claim 1 wherein the moulded material is a plastics material.

5. A set of components configured to form an animal processing station as claimed in claim 1 wherein at least one of the panels is formed from rotationally-moulded plastic components.

6. A set of components configured to form an animal processing station as claimed in claim 1 wherein at least one panel is reinforced by rotational moulding of a secondary layer inside an exterior layer of the panel formed.

7. A set of components configured to form an animal processing station as claimed in claim 6 wherein the secondary layer is composed of a polymer foam.

8. A set of components configured to form an animal processing station as claimed in claim 1 wherein at least one component includes an electromagnetic antenna.

9. A set of components configured to form an animal processing station as claimed in claim 1 wherein the set of components includes a control unit.

10. A set of components configured to form an animal processing station as claimed in claim 1 wherein at least one base panel includes at least one load cell moulded into the base panel.

11. A set of components configured to form an animal processing station as claimed in claim 1 wherein the base panel and at least one side panel are configured to removably interlock directly together.

12. A set of components configured to form an animal processing station as claimed in claim 1 wherein the side panels include a ramp projection along an edge which, when assembled, forms a bottom interior edge with respect to the base panel.

13. A set of components configured to form an animal processing station as claimed in claim 1 wherein at least one of the side panels includes a door.

14. A set of components configured to form an animal processing station as claimed in claim 1 wherein at least a portion of the base panel is inclined towards the side panels when assembled.

15. A set of components configured to form an animal processing station as claimed in claim 2 wherein at least one roof panel is configured to encase wiring.

16. A set of components configured to form an animal processing station as claimed in claim 2 wherein the roof panel is configured to provide a mounting for a control unit.

17. A set of components configured to form an animal processing station as claimed in claim 2 wherein the roof panel includes a central “I” beam structure.

18. A set of components configured to form an animal processing station as claimed in claim 3 wherein at least one side panel and at least one end component are configured such that the position of the side panel with respect to the end component is adjustable when assembled.

19. A set of components configured to form an animal processing station as claimed in claim 3, wherein an end component includes at least two closure elements configured to close together.

20. A set of components configured to form an animal processing station as claimed in claim 3, wherein an end component is configured to engage with a sorting box.

21. An animal processing station formed from a set of components including
at least two side panels which define two opposite sides of the animal processing station, and
at least one base panel,
wherein at least one base panel is configured to interlock, either directly or indirectly, with at least two opposite ends of different side panels, and
wherein at least one of the panels is formed from a reinforced moulded material.

22. An animal processing station as claimed in claim 21 including at least one roof panel, wherein at least one roof panel is configured to removably interlock, either directly or indirectly, with at least two opposite ends of different side panels.

23. An animal processing station as claimed in claim 21 including at least two end components which define opposite ends of the animal processing station.

24. An animal processing station as claimed in claim 21 further including a roof panel and at least two end components, wherein at least one of the side panels is removably interlocked, either directly or indirectly, with the base panel, roof panel and end components.

25. An animal processing station as claimed in claim 21 wherein the position of a side panel with respect to an end component is adjustable.

26. An animal processing station as claimed in claim 21 wherein the moulded material is a plastics material.

27. An animal processing station as claimed in claim 21 wherein at least one of the panels is formed from rotationally-moulded plastic components.

28. An animal processing station as claimed in claim 21 wherein at least one panel is reinforced by rotational moulding of a secondary layer inside the panel formed.

29. An animal processing station as claimed in claim 28 wherein the secondary layer is composed of polymer foam.
